(19) United States
(12) Patent Application Publication
(10) Pub. No.: US 2008/0284550 A1
(43) Pub. Date: Nov. 20, 2008

(54) Variable Inductor

(76) Inventors: Hiroshi Shinmen, Nagano-ken (JP); Mitsuo Matsushima, Nagano-ken (JP)

Correspondence Address: OLIFF & BERRIDGE, PLC, P.O. BOX 320850, ALEXANDRIA, VA, 22320-4850, US

(21) Appl. No.: 11/629,357

(22) PCT Filed: Jun. 8, 2005
(86) PCT No.: PCT/JP05/10492

§ 371 Date: Jan. 30, 2008

(30) Foreign Application Priority Data
Jun. 29, 2004 (JP) 2004-191720

(51) Int. Cl. H01F 21/08

(52) U.S. Cl. 336/155

(57) ABSTRACT

A variable inductor according to the present invention includes a control winding, two windings constituting a primary winding, and a magnetic core. The magnetic core includes a center leg and two outer legs disposed so as to sandwich the center leg, wherein the control winding is disposed around the center leg, and the two winding as the primary winding are disposed around the two outer legs, respectively. The control winding is shifted in location with respect to the two winding as the primary winding in the longitudinal direction of the legs thereby providing a sufficient spatial isolation therefrom, thus ensuring a sufficient withstand voltage between the control winding and the primary winding.

### BACKGROUND OF THE INVENTION

1. Field of the Invention

The present invention relates to a variable inductor, and particularly to a variable inductor in which the permeability of a magnetic core is varied according to a control current flowing in a control winding, thereby controlling inductance of a primary winding.

2. Description of the Related Art

FIG. 4 is a top plan view of a conventional variable inductor (refer, for example, to U.S. Pat. No. 3,631,534). A variable inductor 100 shown in FIG. 4 includes: a magnetic core 110 which has a substantially rectangular frame configuration including a center leg 101 and two outer legs 102 and 103; a center winding (control winding) 111 disposed around the center leg 101; and two outer windings 112 and 113 disposed around the outer legs 102 and 103, respectively, and connected to each other in series so as to constitute a primary winding. In the variable inductor 100, the permeability of the magnetic core 110 is varied by a bias magnetic field generated by a DC current flowing in the control winding 111, whereby the inductance of the primary winding composed of the two outer windings 112 and 113 is controlled.

In such a conventional variable inductor as described above, if the primary winding is connected to a circuit to generate a high voltage for use in, for example, a lighting apparatus for a cold cathode discharge lamp, it is difficult to ensure a sufficient withstand voltage between the primary winding with a high voltage and the control winding with a low voltage while satisfying the requirement for small dimension and low profile.

### SUMMARY OF THE INVENTION

The present invention has been made in light of the above problem, and it is an object of the present invention to provide a variable inductor in which a sufficient withstand voltage is ensured between a primary winding and a control winding while maintaining a small dimension and a low profile.

In order to achieve the object described above, according to an aspect of the present invention, there is provided a variable inductor which includes: a first winding; a second winding composed of two windings which are disposed separate from each other and which are electrically connected to each other, wherein the first winding is disposed so as not to be sandwiched between the two separate windings of the second winding in the same straight line; and a magnetic core having the first and second windings thereon.

In the aspect of the present invention, the magnetic core may include a center leg and first and second outer legs disposed so as to sandwich the center leg, the first winding may be disposed around the center leg, the two windings constituting the second winding may be disposed around the first and second outer legs, respectively, and the first winding may be shifted in position with respect to the two windings of the second winding in the longitudinal direction of the legs.

In the aspect of the present invention, the magnetic core may include a center leg and first and second outer legs disposed so as to sandwich the center leg, the first winding may be disposed around the first outer leg, the two windings constituting the second winding may be disposed around the center leg and the second outer leg, respectively, and the distance between the center leg and the first outer leg may be larger than the distance between the center leg and the second outer leg.

In the aspect of the present invention, the magnetic core may include three legs disposed in a triangular arrangement, the first winding may be disposed around one of the three legs, and the two windings constituting the second winding may be disposed around remaining two legs, respectively.

Thus, in the variable inductor according to the present invention, since the first winding is disposed so as not be sandwiched between the two windings constituting the second winding in the same straight line, a sufficient spatial isolation is ensured between the first and second windings while maintaining the variable inductor at small and low dimension. Accordingly, even in the case one of the first and second windings is designated as primary winding and the other thereof is designated as control winding thus putting the primary winding for use with a high voltage circuit, a sufficient withstand voltage can be achieved between the primary winding and the control winding. Also, the spaces between the first and second windings can be utilized for increasing the numbers on turns on the windings and/or increasing the cross section area of the magnetic path, which enables the variable inductor to be reduced in dimension and profile. Consequently, the variable inductor according to the present invention can be suitably used in a high voltage circuit, especially in a tube current controlling circuit for a lighting apparatus for a cold cathode discharge lamp.

### BRIEF DESCRIPTION OF THE DRAWINGS

FIG. 1 is a top plan view of a variable inductor according to a first embodiment of the present invention;

FIG. 2 is a top plan view of a variable inductor according to a second embodiment of the present invention;

FIG. 3 is an exploded perspective view of a variable inductor according to a third embodiment of the present invention; and

FIG. 4 is a top plan view of a conventional variable inductor.

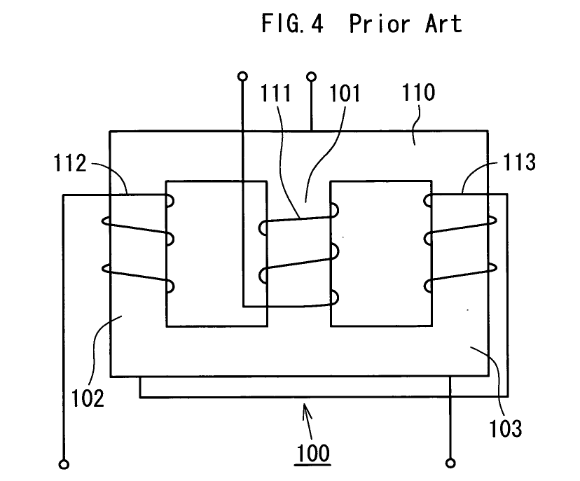

### DETAILED DESCRIPTION OF THE INVENTION

Exemplary embodiments of the present invention will hereinafter be described with reference to the accompanying drawings. In the embodiments described below, description will be made in such a manner that the first winding is designated as a control winding and the second winding composed of two separate windings connected to each other is designated as a primary winding, but the present invention is not limited to such a winding designation, and the first winding may be designated as a primary winding while the second winding is designated as a control winding in the exactly same structure as described with respect to the embodiments, wherein the same advantages described will be achieved.

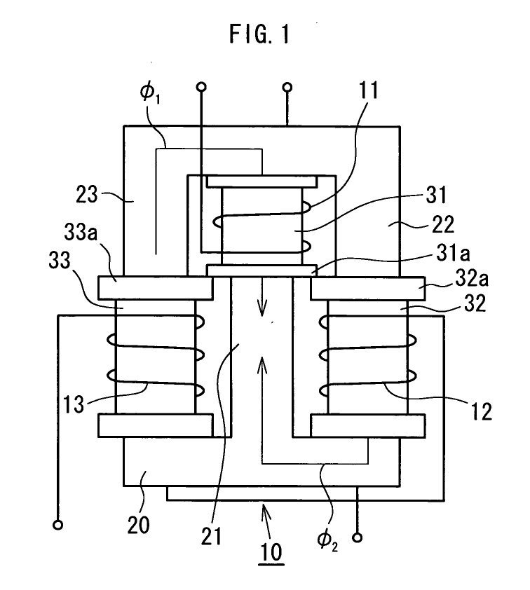

Referring to FIG. 1, a variable inductor 10 according to a first embodiment of the present invention includes a first winding (as control winding) 11, a pair of outer windings 12 and 13 connected to each other in series so as to constitute a second winding (as primary winding), and a magnetic core 20 having the windings 11, 12 and 13 thereon. The magnetic core 20 is composed of two “E” cores formed of a soft magnetic material, for example, Mn—Zn ferrite, or composed of an “E” core and an “I” core, so as to make up a center leg 21 and two (first and second) outer legs 22 and 23 equidistantly sandwiching the center leg 21. The pair of outer windings 12 and 13 as primary winding are wound respectively around bobbins 32 and 33 which are formed of an insulating material and which are disposed around the outer legs 22 and 23, respectively, and the control winding 11 is wound around a bobbin 31 which is formed similarly to the bobbins 32 and 33 and which is disposed around the center leg 21.

In the variable inductor 10 described above, the permeability of the magnetic core 20 is varied by a bias magnetic field generated by a DC current flowing in the control winding 11, whereby the inductance of the windings 12 and 13 as primary winding is variably controlled. In this connection, the control winding 11 is shifted in location relative to the windings 12 and 13 in the longitudinal direction of the legs (vertically in the figure) thereby providing a sufficient spatial isolation therefrom, and consequently a sufficient withstand voltage is ensured between the control winding 11 and the pair of outer windings 12 and 13. The spaces between the center leg 21 and the respective outer legs 22 and 23 can be full utilized for increasing the number of turns on the windings 11, 12 and 13 and also increasing the cross section area of the magnetic path. And, flanges 31a, 32a and 33a of the bobbins 31, 32 and 33 help surely isolate the control winding 11 from the outer windings 12 and 13, which is further advantageous for increasing the withstand voltage between the control winding 11 and the respective outer windings 12 and 13.

In order to suppress the loss resulting from the mutual inductance between those windings, the outer windings 12 and 13 as primary winding are wound and connected to each other such that respective magnetic fluxes φ1 and φ2 generated by energizing the outer windings 12 and 13 are caused to cancel out each other at the center leg 21. Since the magnetic core 20 is structured such that the outer legs 22 and 23 are positioned bilaterally symmetric with respect to the center leg 21, the outer windings 12 and 13 disposed around the outer legs 22 and 23, respectively, are wound with the same number of turns.

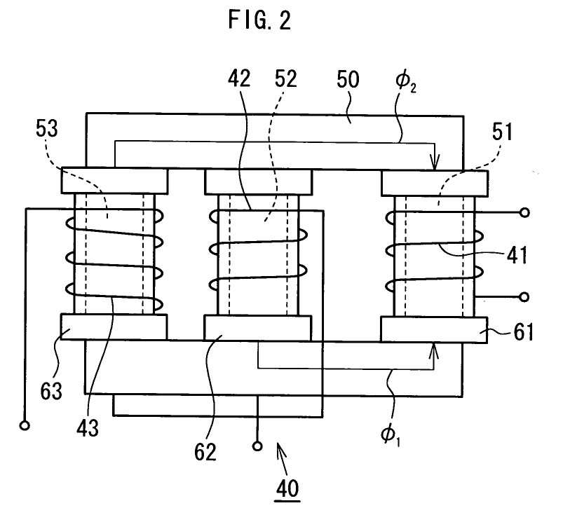

Referring now to FIG. 2, a variable inductor 40 according to a second embodiment of the present invention includes a first outer winding (a first winding as control winding) 41, a center winding 42 and a second outer winding 43 connected to each other in series so as to constitute a second winding (as primary winding), and a magnetic core 50 having the windings 41, 42 and 43 thereon. The magnetic core 50 is composed of two “E” cores formed of a soft magnetic material, for example, Mn—Zn material, or composed of an “E” core and an “I” core, so as to make up a center leg 52 and first and second outer legs 51 and 53 sandwiching the center leg 52, wherein the center leg 52 is positioned so that the distance from the first outer leg 51 thereto is larger than the distance from the second outer leg 53 thereto. The center winding 42 and the second outer winding 43 constituting the second winding as primary winding are wound respectively around bobbins 62 and 63 formed of an insulating material and disposed around the center leg 52 and the second outer leg 53, respectively, and the first outer winding (control winding) 41 is wound around a bobbin 61 which is formed similarly to the bobbin 62 and 63 and which is disposed around the first outer leg 51.

In the variable inductor 40 described above, the permeability of the magnetic core 50 is varied by a bias magnetic field generated by a DC current flowing in the control winding 41, whereby the inductance of the windings 42 and the 43 as the primary winding is variably controlled. In this connection, the distance between the center leg 52 and the first outer leg 51 is larger than the distance between the center leg 52 and the second outer leg 53 so that the control winding 41 is kept at a distance from the primary winding constituted by the winding 42 and 43 so as to secure a sufficient spatial isolation therefrom. The space between the center leg 52 and the first outer leg 51 can be fully utilized for increasing the number of turns on the control winding 41 and also increasing the cross section area of the magnetic path.

In order to suppress the loss resulting from the mutual inductance between those windings, the windings 42 and 43 constituting the primary winding are wound and connected to each other such that respective magnetic fluxes φ1 and φ2 generated by energizing the windings 42 and 43 are caused to cancel out each other at the first outer leg 51. The numbers of turns on the windings 42 and 43 as primary winding are determined to satisfy the formula:

N1/N2=Rm1/Rm2

where N1 is the number of turns on the winding 42; N2 is the number of turns on the winding 43; Rm1 is the magnetic reluctance of the magnetic path defined by the magnetic flux φ1 generated by the winding 42, going through the first outer leg 51 and returning to the center leg 52; and Rm2 is the magnetic reluctance of the magnetic path defined by the magnetic flux φ2 generated by the winding 43, going through the first outer leg 51 and returning to the second outer leg 53.

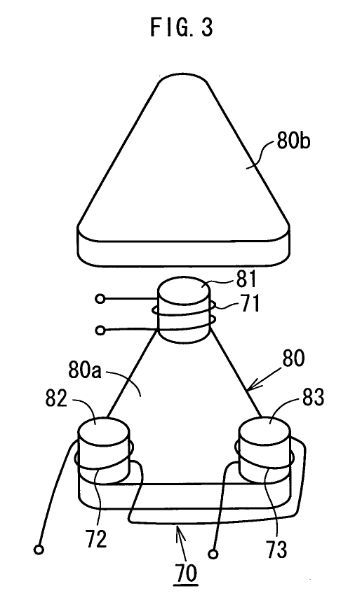

A third embodiment of the present invention will be described with reference to FIG. 3. The drawing and the description explaining the third embodiment will omit bobbins around which windings are wound, but appropriate bobbins adapted according to the configuration of a magnetic core may be used for providing the windings on the magnetic core.

According to FIG. 3, a variable inductor 70 according to the third embodiment includes a first winding (as control winding) 71, a pair of (first and second) windings 72 and 73 connected to each other in series so as to constitute a second winding (as primary winding), and a magnetic core 80 having the windings 71, 72 and 73 thereon. The magnetic core 80 is formed of a soft magnetic material, for example, Mn—Zn ferrite, and includes a base portion 80a, three legs 81, 82 and 83 disposed on the base portion 80a, and a cover portion 80b put on the legs 81, 82 and 83. The base portion 80a is shaped into an isosceles triangle, and the legs 82 and 83 are located at the respective ends of the base side of the isosceles while the leg 81 is located at the apex of the isosceles triangle opposing the base side. In this connection, the remaining two sides of the isosceles triangle having the leg 81 disposed at the junction therebetween are set longer than the base side, wherein the windings 72 and 73 as primary winding are wound around the legs 82 and 83, respectively, and the control winding 71 is wound around the leg 81.

In the variable inductor 70 described above, the permeability of the magnetic core 80 is varied by a bias magnetic field generated by a DC current flowing in the control winding 71, whereby the inductance of the windings 72 and the 73 as the primary winding is variably controlled. In this connection, since the legs 81, 82 and 83 of the magnetic core 80 are located at the respective angles of a triangle, the windings 71, 72 and 73 disposed around the legs 81, 82 and 83 are not disposed in the same straight line, which ensures a sufficient spatial isolation therebetween with a two dimensional spread. And, the spaces between the legs 81, 82 and 83 can be utilized for increasing the numbers of turns on the windings 71, 72 and 73 and also increasing the cross section area of the magnetic path.

In order to suppress the loss resulting from the mutual inductance between those windings, the windings 72 and 73 constituting primary winding are wound and connected to each other such that respective magnetic fluxes (not shown) generated by energizing the windings 72 and 73 are caused to cancel out each other at the leg 81. Since the magnetic core 80 is structured into a substantially isosceles triangle such that the legs 82 and 83 are positioned bilaterally symmetric with respect to a line drawn from the leg 81 orthogonally to the base side of the isosceles triangle, the windings 72 and 73 are wound with the same number of turns.

The legs 81, 82 and 83 of magnetic core 80 are not necessarily set into an isosceles triangle arrangement as described above but may be set into any triangle arrangement. Also, as long as the legs 81, 82 and 83 are set in a triangle arrangement, the base portion 80a and the cover portion 80b do not have to be shaped into a triangular configuration. In case the legs 82 and 83 are not positioned in a bilateral symmetric manner as described above, the numbers of turns on the windings 72 and 73 as primary winding are determined to satisfy the formula:

N1/N2=Rm1/Rm2

where N1 is the number of turns on the winding 72; N2 is the number of turns on the winding 73; Rm1 is the magnetic reluctance of the magnetic path defined by the magnetic flux generated by the winding 72, going through the leg 81 and returning to the leg 82; and Rm2 is the magnetic reluctance of the magnetic path defined by the magnetic flux generated by the winding 73, going through the first leg 81 and returning to the leg 83

In all the embodiments described above, the first winding (11/41/71) is designated as control winding, and the second winding composed of two windings (12 & 13/42 & 43/72 & 73) disposed separate from each other is designated as primary winding. However, as mentioned earlier, the first winding (11/41/71) can be used as primary winding, and the second winding (12 & 13/42 & 43/72 & 73) can be used as control winding. Generally speaking, since a two winding structure is suitable for increasing the number of turns, it is preferred to designate the second winding (12 & 13/42 & 43/72 & 73) as primary when a high inductance needs to be achieved at the primary winding, while it is preferred to designate the second winding (12 & 13/42 & 43/72 & 73) as control winding when the inductance of the primary winding needs to be controlled by a lower DC current.

What is claimed is:

1. A variable inductor comprising:
a first winding;
a second winding composed of two windings which are disposed separate from each other and which are electrically connected to each other, wherein the first winding is disposed so as not to be sandwiched between the two separate windings of the second winding in a same straight line; and
a magnetic core having the first and second windings thereon.

2. A variable inductor according to claim 1, wherein the magnetic core comprises a center leg and first and second outer legs disposed so as to sandwich the center leg, the first winding is disposed around the center leg, the two windings constituting the second winding are disposed around the first and second outer legs, respectively, and the first winding is shifted in position with respect to the two windings of the second winding in a longitudinal direction of the legs.

3. A variable inductor according to claim 1, wherein the magnetic core comprises a center leg and first and second outer legs disposed so as to sandwich the center leg, the first winding is disposed around the first outer leg, the two windings constituting the second winding are disposed around the center leg and the second outer leg, respectively, and a distance between the center leg and the first outer leg is larger than a distance between the center leg and the second outer leg.

4. A variable inductor according to claim 1, wherein the magnetic core comprises three legs disposed in a triangular arrangement, the first winding is disposed around one of the three legs, and the two windings constituting the second winding are disposed around remaining two legs, respectively.
